(19) United States
(12) Patent Application Publication
(10) Pub. No.: US 2017/0129202 A1
(43) Pub. Date: May 11, 2017

(54) PRESSED POWDER ELEMENT FORMING MACHINE

(71) Applicant: HAO YING MACHINE ENTERPRISE CO., LTD., Tainan City (TW)

(72) Inventor: Chin-Chun SU, Tainan City (TW)

(21) Appl. No.: 14/933,215

(22) Filed: Nov. 5, 2015

(51) Int. Cl. B30B 15/00; B30B 11/04

(52) U.S. Cl. CPC B30B 15/0017; B30B 11/04

(57) ABSTRACT

A pressed powder element forming machine is provided, in which an adjustable core insert is provided in a compression chamber of a machine body and a forming space is provided between the compression chamber and the core insert. A sealing cover is used to close the forming space through a breathable material. When making dry or wet pressed powder element, dry loose powder or wet loose powder is fed into the forming space and the core insert is actuated to press the dry loose powder or wet loose powder into pre-pressed powder blank. Simultaneously, an evacuating power source connected between the sealing cover and the machine body performs air evacuation or solvent extraction from the forming space, so as to press the loose powder into compact pressed powder element. In this manner, production efficiency of making pressed powder element is increased.

### BACKGROUND OF INVENTION

Field of the Invention

The present invention relates to a pressed powder element forming machine, more particularly to a pressed powder element forming machine which can increase production capacity of dry or wet type pressed powder element, enable significant improvement on pressed powder element quality, provide multi-color and multi-shape pressed powder element production, and reduce dust contamination.

Brief Description of Prior Art

Current pressed powder element production methods can be divided into dry type and wet type pressed powder element forming method. Conventional dry type pressed powder element forming method is to manually compact loose powder in an aluminum pan into cake shape by a jig, while the wet type pressed powder element forming method additionally adds the steps of mixing solvent in the loose powder and then removing the solvent after the process of compaction in the aluminum pan. However, as traditional production mode of multi-color pressed powder element either in dry or wet type pressed powder element forming method is limited by powder feeding mode and machine performance, not only production of pressed powder element is extremely complicated and production cost is very high, but also variability of pressed powder element is low.

Referring to U.S. Pat. No. 8,636,933B2 entitled “Pressed powder element”, a pressed powder element forming machine commonly available on market is disclosed. The pressed powder element forming machine mainly has a compression chamber provided in the machine body and an adjustable die provided in the compression chamber the volume of which can be changed according to the movement of the die along the compression chamber. When in production, loose powder is fed into the compression chamber through a feeding pipe located beneath the machine body. The feeding of loose power is stopped when the compression chamber is filled with loose powder. Next, the die is displaced downward so that the die bottom can compact the loose powder. Simultaneously, a pneumatic source on the upper side of the machine body is actuated to create a negative pressure to extract air in the compression chamber through the perforations provided on the die bottom, so as to compact the loose powder. Next, the pneumatic source produces a positive pressure applied through the perforations on the die bottom to blow off the pressed powder element affixed to the die bottom. Then, the pressed powder element detached from the die bottom falls down into and is held by an aluminum pan so as to finish the production of pressed powder element.

The pressed powder element forming machine disclosed in U.S. Pat. No. 8,636,933B2 entitled “Pressed powder element” can provide automatic production of pressed powder element, but it has following disadvantages found in its practical implementation.

1. When extracting the air in the compression chamber through the perforations provided on the die bottom by negative pressure created from the pneumatic source of the pressed powder element forming machine, in order to avoid the extraction of the loose powder out of the compression chamber together with the air, the diameter of perforations on the die bottom should be made smaller than that of the loose powder. However, smaller apertures are unfavorable to the evacuation of air. Moreover, one-way evacuation conducted by a single pneumatic source may cause slower evacuation operation, resulting in longer labor hour and low production capacity. This is not in line with high performance needs emphasized by modern industries.

2. When extracting the air in the compression chamber through the perforations provided on the die bottom, loose powder may be drawn to affix to the perforations. As the loose powder has certain stickiness, the perforations may be blocked by the loose powder after use for a period of time, and this may cause difficulty in air evacuation. In order to solve the problem of perforation blocking, frequent clean-up operation is unavoidable and this will cause increased production line shutdown and maintenance cost and inconvenient operation. Moreover, production line shutdown due to frequent maintenance operation results in yield loss.

3. When the pneumatic source of the pressed powder element forming machine changes to positive pressure to blow off the pressed powder element affixed to the die bottom into the aluminum pan, the surface affixed to the die bottom will be faced up and the shape of perforations of the die bottom is left on that surface, impurities and residual powder will also stick to that surface, causing contamination and unevenness on that pressed powder surface. Thus, sales appeal becomes worsened and sales rate is hindered.

Further, a Taiwanese Patent Pub. No. TW M370963U1 entitled “Multi-color pressed powder element forming mechanism” proposed by the inventor of the present invention mainly comprises a feeding unit, a forming unit and a dehydration unit assembled in this sequence. A feeding syringe of the feeding unit injects powder paste in semi-solid state into several compartments of the forming unit. Next, the dehydration unit removes water content contained in the powder paste so as to form multi-color pressed powder element. Although the “Multi-color pressed powder element forming mechanism” of Taiwanese Patent Pub. No. TW M370963U1 can achieve automatic production of pressed powder element, it has not reached perfect state yet. Hence, the inventor of the present invention, taking the philosophy of constantly striving for perfection, proposes the pressed powder element forming machine of the present invention by ingenious thinking in many ways and according to his abundant experience on product development and manufacturing in relevant field and based on the assistance of specialized knowledge.

### SUMMARY OF THE INVENTION

The main object of the present invention is to provide a pressed powder element forming machine, which can increase production capacity of dry type and wet type pressed powder element, effectively improve the quality of pressed powder element, enable multi-color production, enable pressed powder element production in various shape, and reduce dust contamination.

In order to achieve above object, the pressed powder element forming machine of the present invention mainly comprises:

a machine body having at least one compression chamber, one end of which being formed with an open end and the other end a closed end; an adjustable core insert being provided in the compression chamber in such a manner that a forming space is defined in the compression chamber by the core insert and the open end of the compression chamber; the machine body having a feeding unit corresponding to and communicating with the forming space;

a sealing cover located on the open end of the compression chamber; the sealing cover having a plurality of through bores provided on its end face corresponding to the compression chamber and communicated with a hollow cavity inside the sealing cover; the sealing cover further having an evacuation unit provided to correspond to and to communicate with the hollow cavity;

a breathable material, formed with a plurality of pores thereon, located between the machine body and the sealing cover to close the open end of the compression chamber in such a manner that the sealing cover closes the open end of the compression chamber through the breathable material.

According to the above pressed powder element forming machine of the present invention, the adjustable core insert is further connected with one end of a transmission rod, and the close end of the compression chamber has an aperture for penetration of the other end of the transmission rod to the outside of the compression chamber so as to be coupled to a retractable power source; the evacuation unit of the sealing cover is further coupled to an evacuating power source; a dry powder source is connected to the feeding unit of the machine body in such a manner that the evacuating power source can draw the dry powder from the dry powder source into the forming space; the sealing cover is further coupled to a feeding power source; moreover, a folding power source is provided to couple with the breathable material.

According to the above pressed powder element forming machine of the present invention, a stroke space is defined in the compression chamber by the adjustable core insert and the close end of the compression chamber; further, an evacuation unit corresponding to the forming space is provided on the machine body and is communicated with the stroke space; moreover, the evacuating unit is coupled with an evacuating power source; furthermore, a plurality of perforations are provided to penetrate across the adjustable core insert.

According to the above pressed powder element forming machine of the present invention, the evacuating power source coupled to the evacuation unit of the sealing cover and the evacuating power source coupled to the evacuation unit of the machine body are vacuum pumps or any means enabling generation of negative pressure in space.

According to the above pressed powder element forming machine of the present invention, the adjustable core insert is further connected with one end of a transmission rod, and the close end of the compression chamber has an aperture for penetration of the other end of the transmission rod to the outside of the compression chamber so as to be coupled to a retractable power source; furthermore, the evacuation unit of the sealing cover is coupled to an evacuating power source; a delivering unit is connected to the feeding unit of the machine body and the delivering unit is connected to a wet powder source so that the wet loose powder in the wet powder source can be fed by the delivering unit into the forming space; moreover, the evacuation unit is coupled to an evacuating power source; furthermore, a folding power source is provided to couple with the breathable material.

According to the above pressed powder element forming machine of the present invention, a stroke space is defined in the compression chamber by the adjustable core insert and the close end of the compression chamber; further, an evacuation unit corresponding to the forming space is provided on the machine body and is communicated with the stroke space; moreover, the evacuating unit is coupled with an evacuating power source; furthermore, a plurality of perforations are provided to penetrate across the adjustable core insert.

According to the above pressed powder element forming machine of the present invention, the evacuating power source coupled to the evacuation unit of the sealing cover and the evacuating power source coupled to the evacuation unit of the machine body are water pumps or any means enabling generation of negative pressure in space.

According to the above pressed powder element forming machine of the present invention, the pressed powder element forming machine further has a pick-up unit passing between the machine body and the breathable material, and the pick-up unit is coupled to a displacement power source.

Configuring in this manner, when making dry or wet pressed powder element, dry loose powder or wet loose powder is fed into the forming space and the core insert is actuated to press the dry loose powder or wet loose powder into pre-pressed powder blank. Simultaneously, the evacuating power source connected between the sealing cover and the machine body performs air evacuation or solvent extraction from the forming space, so as to compacting the pre-pressed powder blank into pressed powder element. In this manner, according to the two-way air evacuation or solvent extraction performed by the evacuating power source connected between the sealing cover and the machine body, efficiency of producing pressed powder element can be increased. Additionally, by enabling the replacement of new breathable material segment, the surface of the pressed powder element can be contacted with clean breathable material segment so that cleanness, non-pollution, and flatness of the surface of the pressed powder element can be ensured. Furthermore, by feeding loose powder of different colors and changing the shape of the core insert, pressed powder element with single-color, multi-color and various shape can be easily produced.

### BRIEF DESCRIPTION OF THE DRAWINGS

FIG. 1 is an exploded view of the present invention;

FIG. 2 is a view showing a state of feeding dry powder of the present invention;

FIG. 3 is a view of forming the pressed powder element from dry powder of the present invention;

FIG. 4 is a view showing the state of ejecting the pressed powder element of the present invention;

FIG. 5 is a view showing the state of taking out the pressed powder element of the present invention;

FIG. 6 is an exploded view of another embodiment of the present invention;

FIG. 7 is a view showing a state of feeding wet powder of the present invention;

FIG. 8 is a view of forming the pressed powder element from wet powder of the present invention.

### DETAILED DESCRIPTION OF PREFERRED EMBODIMENTS

The technical contents, objects and effect of the present invention will become more apparent by the detailed description in conjunction with the accompanying drawings.

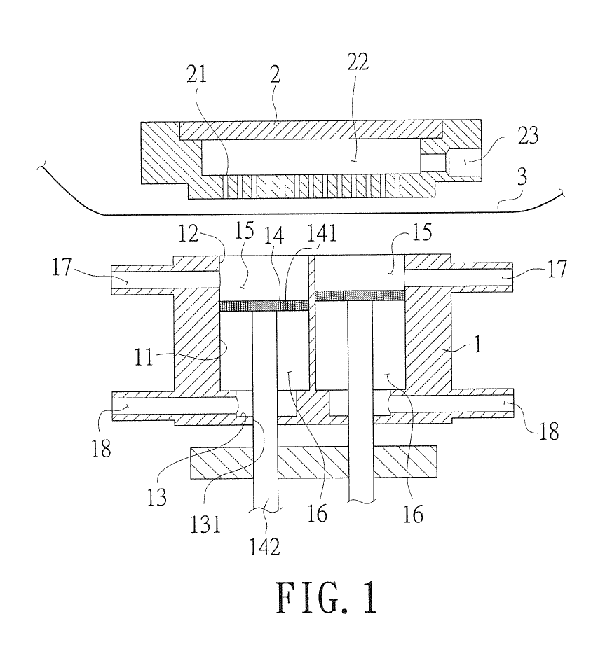

Firstly, as shown in FIG. 1, a pressed powder element forming machine of the present invention mainly comprises:

a machine body (1) having at least one compression chamber (11), for example two adjacent compression chambers (11) as the main embodiment of the present invention, one end of which being formed with an open end (12) and the other end being a closed end (13) having a aperture (131) at its center; the compression chamber (11) is provided with an adjustable core insert (14) which has a plurality of perforations (141) penetrating across the core insert (14), and which is further connected with one end of a transmission rod (142), and the other end of the transmission rod (142) penetrates through the aperture (131) to the outside of the compression chamber (11); further, a forming space (15) being defined in the compression chamber (11) by the adjustable core insert (14) and the open end (12) of the compression chamber (11), and a stroke space (16) being defined in the compression chamber (11) by the adjustable core insert (14) and the close end (13) of the compression chamber (11); a feeding unit (17) corresponding to the forming space (15) being provided on the lateral side of the machine body (1) and being communicated with the forming space (15); an evacuation unit (18) corresponding to the stroke space (16) being provided on the lateral side of the machine body (1) and being communicated with the stroke space (16);

a sealing cover (2) located on the open end (12) of the compression chamber (11) of the machine body (1); the sealing cover (2) having a plurality of through bores (21) provided on its end face corresponding to the compression chamber (11) and communicated with a hollow cavity (22) of the sealing cover (2); the sealing cover (2) further having an evacuation unit (23) provided on its lateral side corresponding to the hollow cavity (22) and communicated with the hollow cavity (22);

a breathable material (3), which can be breathable fabric formed with a plurality of pores thereon, located between the machine body (1) and the sealing cover (2) to close the open end (12) of the compression chamber (11) in such a manner that the sealing cover (2) closes the open end (12) of the compression chamber (11) through the breathable material (3);

a pick-up unit (4) passing between the machine body (1) and the breathable material (3), which can be any means having evacuation power or enabling transfer of the pressed powder element to the aluminum pan. The present invention provides a breathable plate having a plurality of perforations formed thereon, which cooperates with a evacuating power source enabling the generation of negative pressure for sucking the pressed powder element as implementation embodiment.

Configuring like this, when manufacturing dry type pressed powder element, the feeding unit (17) of the machine body (1) is connected to a dry powder source and the evacuation unit (18) of the machine body (1) is connected to an evacuating power source which can be a vacuum pump or any means enabling generation of negative pressure in space. Furthermore, one end of the transmission rod (142) of the core insert (14) penetrating to the outside of the compression chamber (11) is coupled to a retractable power source which can be a pneumatic cylinder. The breathable material (3) is coupled to a folding power source, and the evacuation unit (23) of the sealing cover (2) is connected to an evacuating power source which can be a vacuum pump or any means enabling the generation of negative pressure in space. Also, the sealing cover (2) is connected to a feeding power source which can be a pneumatic cylinder. The pick-up unit (4) is coupled to a displacement power source which can be a pneumatic cylinder, and the pick-up unit (4) is connected to an evacuating power source which can be a vacuum pump or any means enabling the generation of negative pressure in space. Again, the retractable power source, the folding power source, the feeding power source, the displacement power source and each of the evacuating power sources are connected to a control unit so as to enable automatic production of dry type pressed powder element.

When in implementation, the control unit starts to actuate the feeding power source connected to the sealing cover (2), so as to allow the sealing cover (2) feeding toward the direction of the machine body (1). At this moment, the breathable material (3) between the machine body (1) and the sealing cover (2) is also heading together with the sealing cover (2) toward the direction of the machine body (1) so that the breathable material (3) may cover the open end (12) of the compression chamber (11) of the machine body (1), and thus the sealing cover (2) can close the open end (12) of the compression chamber (11) tightly through the breathable material (3).

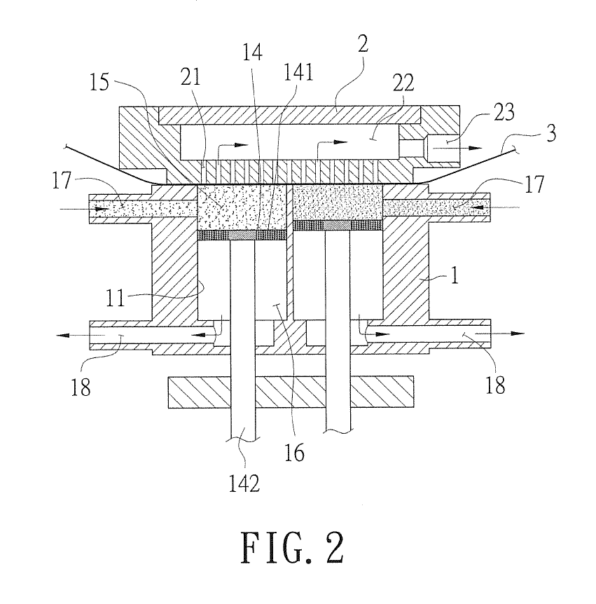

As shown in FIG. 2, the control unit in turn drives the evacuating power source connected with the evacuation unit (23) of the sealing cover (2), so that the air in the forming space (15) is drawn out by the evacuation unit (23) through the hollow cavity (22) and its through bores (21) and then through the pores of the breathable material (3), to make the forming space (15) in a state of negative pressure. At this moment, the dry loose powder in the dry powder source connected to the feeding unit (17) of the machine body (1) is sucked into the forming space (15) by the negative pressure therein, simultaneously the control unit actuates the evacuating power source connected to the evacuation unit (18) of the machine body (1) so that the air in the forming space (15) of the compression chamber (11) is drawn out through the plurality of perforations (141) provided on the core insert (14). The dry loose powder is synchronously drawn into the forming space (15). In this manner, the feeding efficiency of dry loose powder into the forming space (15) is increased.

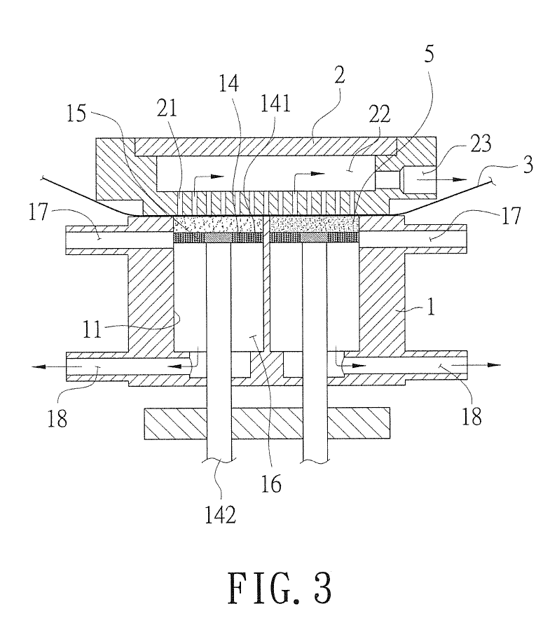

Referring to FIG. 3 too, again the control unit drives the retractable power source so that the transmission rod (142) connected with the retractable power source drives to actuate the core insert (14) moving toward the direction of open end (12) of the compression chamber (11), then the dry loose powder within the forming space (15) is compressed into pre-pressed powder blank, simultaneously the air coming together with the dry loose powder into the forming space (15) is removed out of the forming space (15) through the perforations (141) provided on the core insert (14). At this moment, the evacuating power sources connected with the sealing cover (2) and the machine body (1) continue the evacuation operation so as to increase the air extraction efficiency in the forming space (15). After the air in the forming space (15) is completely exhausted, the pre-pressed powder blank formed by the dry loose powder is compressed tightly to form a pressed powder element (5). Furthermore, it is noted herein that the volume of incoming powder and the thickness of the pressed powder element (5) can be adjusted by regulating the stroke of the core insert (14).

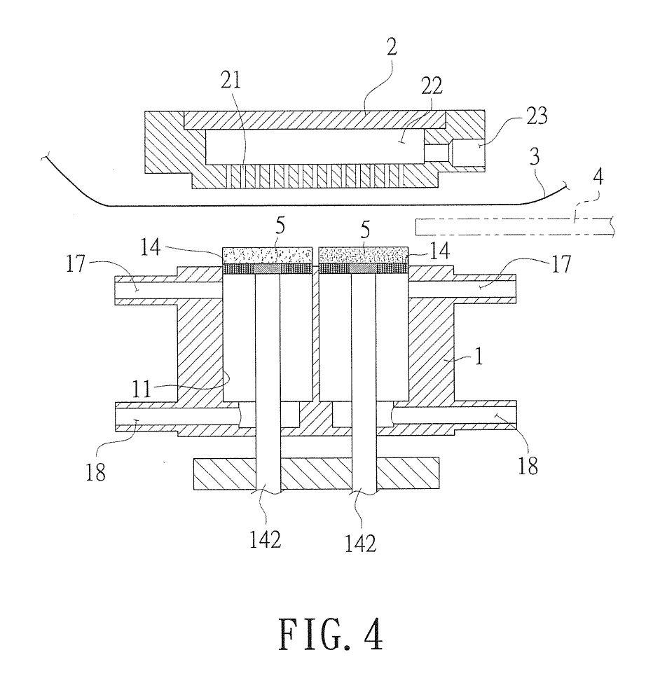

Referring to FIG. 4 too, again the control unit drives the feeding power source connected with the sealing cover (2) so as to return the sealing cover back to its original position, and the evacuating power source connected with the sealing cover (2) is stopped, and the control unit further drives the folding power source connected therewith to fold the breathable material (3) detached from the abutment against the sealing cover (2) to a certain stroke, so that the segment of the breathable material (3) providing the formation of the pressed powder element (5) this time is allowed to leave the position in the compression chamber (11), and then the next clean segment of the breathable material (3) is shifted to the position in the compression chamber (11). So, during formation of the pressed powder element (5) each time, the segment of the breathable material (3) providing the formation of the pressed powder element (5) can be maintained to be very clean so as to prevent the pressed powder element from improper contamination and buildup of impurities and residual powder and to achieve cleanness and flatness of surface of the pressed powder element (5). Furthermore, affixation and clogging of dry loose powder in the pores of that segment of the breathable material (3) can also be avoided so as to maintain smooth evacuation. Then, the control unit drives the evacuating power source connected to the evacuation unit (18) of the machine body (1) to change into positive pressure which is inputted through the perforations (141) of the core insert (14), so that the pressed powder element (5) is detached from the affixation with the core insert (14). Next, the control unit drives the retractable power source so that the transmission rod (142) can drives the core insert (14) to eject the pressed powder element (5) out of the forming space (15).

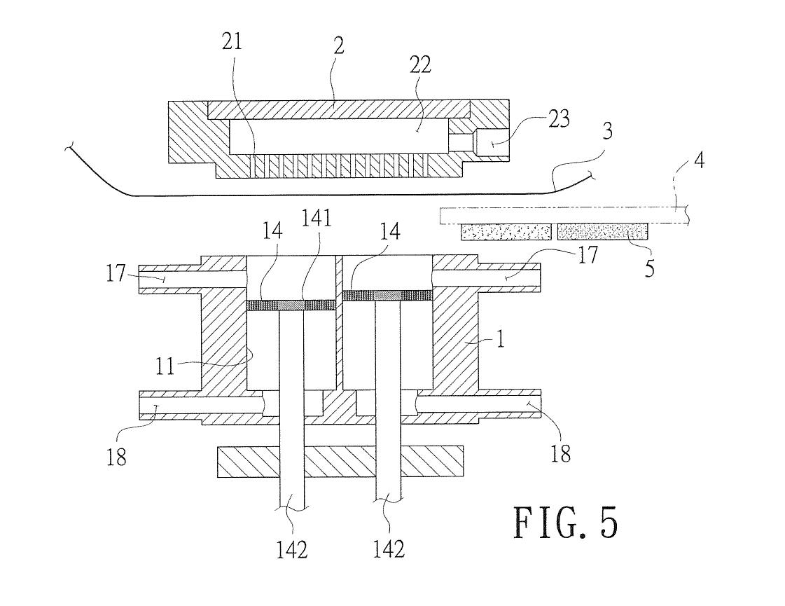

Referring to FIG. 5 too, again the control unit drives the displacement power source connected with the pick-up unit (4) so as to drives the pick-up unit (4) to displace to the pressed powder element (5), then the control unit drives to actuate the evacuating power source connected with the pick-up unit (4) so as to suck the pressed powder element (5) on the pick-up unit (4). Next, the control unit again drives the displacement power source connected with the pick-up unit (4) so as to retreats the pick-up unit (4) to its original position, in turn the evacuating power source of the pick-up unit (4) is stopped so as to release the sucking of the pressed powder element (5), and the pressed powder element (5) then fall off and held by a aluminum pan preset below. Next, the control unit drives the sealing cover (2) to move toward the direction of the machine body (1) so as to close the open end (12) of the compression chamber (11) in tight condition through the breathable material (3). When conducting the formation of next pressed powder element, the control unit drives the evacuating power source connected with the evacuation unit (18) of the machine body (1) to delivery air into the compression chamber (11) so as to blow off dry loose powder affixed to the perforations (141) of the core insert (14). According to the steps of closing the sealing cover (2) first and blowing-off dry loose powder later, the problem of dry loose powder dispersing in the ambient atmosphere to cause dust contamination in environment can be effectively avoided.

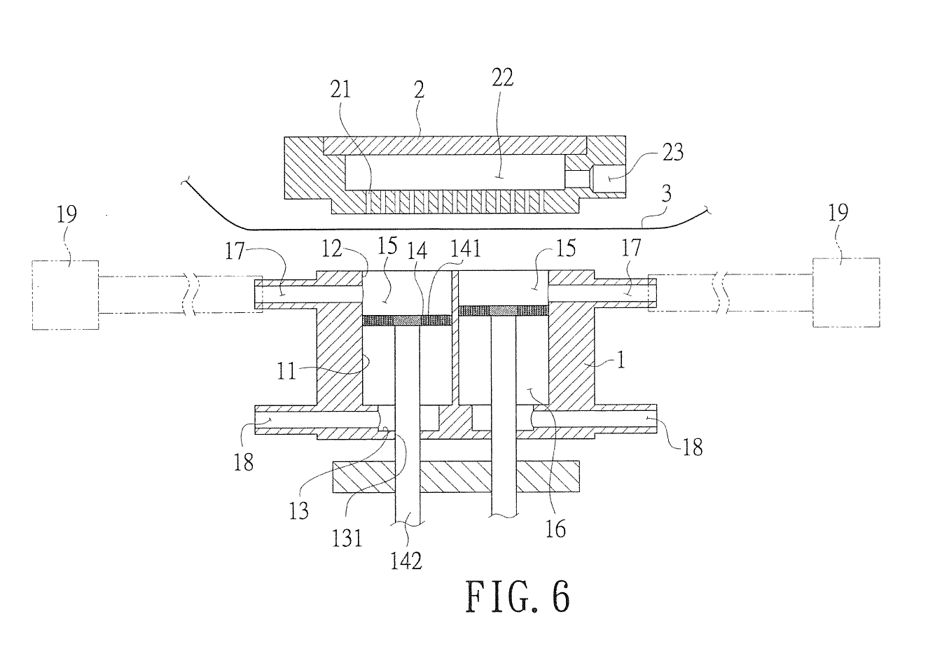

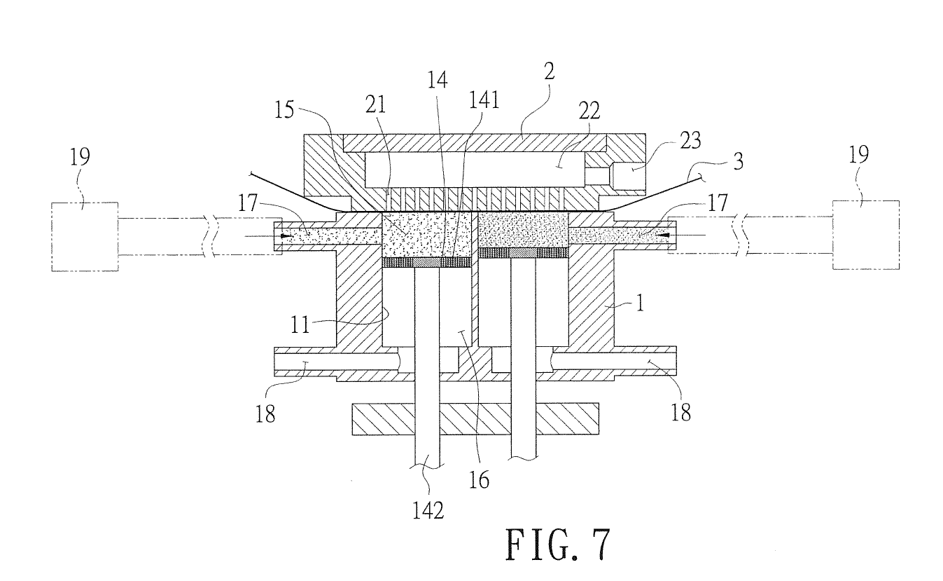

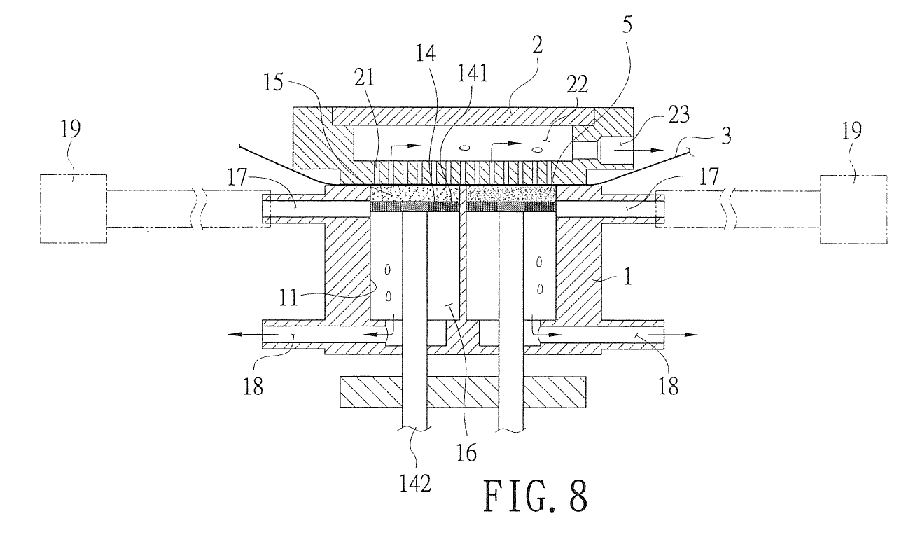

Moreover, when manufacturing wet type pressed powder element by the present invention, referring to FIG. 6 too, a delivering unit (19) is further provided to connect with the feeding unit (17) of the machine body (1) so as to be couple to the control unit. The delivering unit (19) can be a screw feeding mechanism powered by a motor, and the delivering unit (19) is connected to a wet powder source. Additionally, the evacuating power sources connected with the evacuation unit (18) of the machine body (1) and the evacuation unit (23) of the sealing cover (2) are water pumps or any means enabling the generation of negative pressure in space. Referring to FIG. 7 too, when in implementation, the delivering unit (19) delivers wet loose powder containing solvent mixed therein from the wet loose powder source to the forming space (15) by the feeding unit (17), or the wet loose powder can be poured directly into the forming space (15) through the open end (12) of the compression chamber (11), and then the wet loose powder is compressed into pre-pressed powder blank by the core insert (14). Next, referring to FIG. 8 too, the air and the solvent of the wet loose powder contained in the forming space (15) are extracted out by the evacuating power source connected with the evacuation unit (18) of the machine body (1) through the perforations (141) of the core insert (14), simultaneously the air and the solvent of the wet loose powder contained in the forming space (15) can also be drawn out by the evacuating power source connected with the evacuation unit (23) of the sealing cover (2) through the breathable material (3). After complete evacuation of the air and solvent in the forming space (15), the pre-pressed powder blank formed by wet loose powder is formed into compact pressed powder element (5). Next, the sealing cover (2) is retreated to its original position and the breathable material (3) is folded up, and the core insert (14) ejects the pressed powder element (5) out of the forming space (15), then the pick-up unit (4) sucks the pressed powder element (5) and put it in an aluminum pan.

The above embodiment or drawings are not to limit the aspect of the pressed powder element forming machine of the present invention. For example, the compression chamber (11) of the machine body (1) of the present invention is not limited to one or two, but can be formed into more than 3 adjacent compression chambers (11) and dry loose powder or wet loose powder of different color can also be fed into various forming space (15) of each compression chamber (11). In this manner, manufacturing of multi-color pressed powder element can be realized. Furthermore, the evacuation unit (18) of the machine body (1) and the associated evacuating power source can be omitted, so the operation of air evacuation and solvent extraction can be conducted solely by the evacuating power source connected with the evacuation unit (23) of the sealing cover (2). Moreover, pressed powder element of single-color, multi-color and various shape can be easily produced by feeding loose powder of different color or by changing the shape of the core insert. Equivalent variations and modifications conducted by person skilled in the art without departing from the spirit and scope of the present invention should be considered to be still within the scope of the present invention.

Based on foregoing, it is apparent that the present invention has the following advantages.

1. The pressed powder element forming machine of the present invention has evacuation units respectively provided on the machine body and the sealing cover and connected to the evacuating power sources. By means of the synchronous actuation of the two evacuating power sources connected respectively with the machine body and the sealing cover, the feeding efficiency of drawing the loose powder into the forming space can be increased. Furthermore, by the two-way evacuation of the machine body and the sealing cover, the efficiency of extracting both the air and solvent in dry loose powder or wet loose powder so as to compact the pressed powder element can be increased. Moreover, by the shielding effect of the breathable material, the diameter of the perforations of the sealing cover can be properly enlarged so as to further increase the evacuation efficiency. In this manner, the production capacity of making the pressed powder element can be effectively increased.

2. The pressed powder element forming machine of the present invention has the breathable material provided between the machine body and the sealing cover, and the breathable material can be scrolled to change segment so that during the formation of pressed powder element each time, the surface of the pressed powder element can contact with a clean segment of the breathable material. Therefore, the condition of residual powder or impurities left on the breathable material on last time production of pressed powder element can be avoided so as not to cause contamination and unevenness on the surface of pressed powder element. Moreover, when the pressed powder element is disposed on the aluminum pan, the surface contact with the core insert is disposed on the aluminum pan, while the surface in contact with the breathable material is facing up so that clean and flat pressed powder element of high quality without contamination can be produced, and effect of attracting consumer to buy and increasing its sales rate can be achieved.

3. The pressed powder element forming machine of the present invention can easily produce pressed powder element of single-color, multi-color and various shape by feeding loose powder of different color or by changing the shape of the core insert. Particularly, the present invention can achieve the effect of preventing the loose powder from dispersing in the ambient air so as not to cause dust contamination by using the sealing cover to close the open end of the compression chamber first and blowing off the loose powder affixing to the core insert later.

4. The pressed powder element forming machine of the present invention can be adaptable to the manufacturing of pressed powder element by dry loose powder and wet loose powder. Therefore, pressed powder element makers need not to buy dry type and wet type pressed powder element forming machines respectively. Hence, manufacturing cost can be lowered.

What is claimed is:

1. A pressed powder element forming machine, mainly comprising:
a machine body having at least one compression chamber, one end of which being formed with an open end and the other end of which being formed with a closed end; an adjustable core insert being provided in the compression chamber in such a manner that a forming space is defined in the compression chamber by the core insert and the open end of the compression chamber; the machine body having a feeding unit corresponding to and communicating with the forming space;
a sealing cover located on the open end of the compression chamber; the sealing cover having a plurality of through bores provided on its end face corresponding to the compression chamber and communicated with a hollow cavity inside the sealing cover; the sealing cover further having an evacuation unit provided to correspond to and to communicate with the hollow cavity;
a breathable material, formed with a plurality of pores thereon, located between the machine body and the sealing cover to close the open end of the compression chamber in such a manner that the sealing cover closes the open end of the compression chamber through the breathable material.

2. The pressed powder element forming machine as claimed in claim 1, wherein the adjustable core insert is further connected with one end of a transmission rod, and the close end of the compression chamber has an aperture for penetration of the other end of the transmission rod to the outside of the compression chamber so as to be coupled to a retractable power source; the evacuation unit of the sealing cover is further coupled to an evacuating power source; a dry powder source is connected to the feeding unit of the machine body; the sealing cover is further coupled to a feeding power source; moreover, a folding power source is provided to couple with the breathable material.

3. The pressed powder element forming machine as claimed in claim 2, wherein a stroke space is defined in the compression chamber by the adjustable core insert and the close end of the compression chamber; further, an evacuation unit corresponding to the stroke space is provided on the machine body and is communicated with the stroke space; moreover, the evacuation unit is coupled with an evacuating power source; furthermore, a plurality of perforations are provided to penetrate across the adjustable core insert.

4. The pressed powder element forming machine as claimed in claim 3, wherein the evacuating power source coupled to the evacuation unit of the sealing cover and the evacuating power source coupled to the evacuation unit of the machine body are vacuum pumps.

5. The pressed powder element forming machine as claimed in claim 1, wherein the adjustable core insert is further connected with one end of a transmission rod, and the close end of the compression chamber has an aperture for penetration of the other end of the transmission rod to the outside of the compression chamber so as to be coupled to a retractable power source; furthermore, the evacuation unit of the sealing cover is coupled to an evacuating power source; a delivering unit is connected to the feeding unit of the machine body and the delivering unit is connected to a wet powder source; the sealing cover is further coupled to a feeding power source; moreover, a folding power source is provided to couple with the breathable material.

6. The pressed powder element forming machine as claimed in claim 5, wherein a stroke space is defined in the compression chamber by the adjustable core insert and the close end of the compression chamber; further, an evacuation unit corresponding to the stroke space is provided on the machine body and is communicated with the stroke space; moreover, the evacuation unit is coupled with an evacuating power source; furthermore, a plurality of perforations are provided to penetrate across the adjustable core insert.

7. The pressed powder element forming machine as claimed in claim 6, wherein the evacuating power source coupled to the evacuation unit of the sealing cover and the evacuating power source coupled to the evacuation unit of the machine body are water pumps.

8. The pressed powder element forming machine as claimed in claim 1, wherein the pressed powder element forming machine further has a pick-up unit passing between the machine body and the breathable material, and the pick-up unit is coupled to a displacement power source.
